(19) United States
(12) Patent Application Publication
(10) Pub. No.: US 2025/0308749 A1
(43) Pub. Date: Oct. 2, 2025

(54) COIL COMPONENT AND METHOD OF MANUFACTURING THE SAME

(71) Applicant: TAIYO YUDEN CO., LTD., Tokyo (JP)

(72) Inventors: Kengo TSUCHIYA, Tokyo (JP); Takashi NAKAJIMA, Tokyo (JP); Yukina KOJIMA, Tokyo (JP)

(21) Appl. No.: 19/075,249

(22) Filed: Mar. 10, 2025

(30) Foreign Application Priority Data
Mar. 29, 2024 (JP) 2024-056411

(51) Int. Cl. H01F 27/28; H01F 1/08; H01F 27/06

(52) U.S. Cl. CPC H01F 27/2804; H01F 1/086; H01F 27/06; H01F 2027/065; H01F 2027/2809

(57) ABSTRACT

One object is to improve the insulation between conductor patterns without reducing the effective permeability. A magnetic base body according to one embodiment includes: a coil conductor provided in the magnetic base body so as to extend around a coil axis; a first external electrode electrically connected to one end of the coil conductor; and a second external electrode electrically connected to another end of the coil conductor. The coil conductor includes a first conductor pattern and a second conductor pattern opposed to the first conductor pattern in a first direction along the coil axis. The magnetic base body includes a first region and a second region, the first region containing a plurality of metal magnetic particles, the second region containing composite oxide particles containing Fe, Ni, and Zn, the second region being magnetic and insulating and being interposed between the first conductor pattern and the second conductor pattern.

### CROSS-REFERENCE TO RELATED APPLICATIONS

This application is based on and claims the benefit of priority from Japanese Patent Application Serial No. 2024-056411 (filed on Mar. 29, 2024), the contents of which are hereby incorporated by reference in their entirety.

### TECHNICAL FIELD

The present disclosure relates mainly to a coil component and a method of manufacturing the coil component.

### BACKGROUND

A coil component includes a base body, a coil conductor provided in the base body, a first external electrode attached to one end of the coil conductor, and a second external electrode attached to the other end of the coil conductor. A certain type of magnetic base body contains a plurality of metal magnetic particles bonded to each other. The magnetic base body made of the metal magnetic particles is less prone to magnetic saturation than a magnetic base body made of ferrite. Therefore, a coil component including a magnetic base body made of metal magnetic particles is suitable for large-current circuits (e.g., power supply circuits and DC/DC converter circuits).

A conventional coil component including a magnetic base body made of metal magnetic particles is disclosed in Japanese Patent Application Publication No. 2016-051752 (“the '752 Publication”).

As mentioned in the '752 Publication, when a coil component including a magnetic base body made of metal magnetic particles has small intervals between conductor patterns constituting the coil conductor, dielectric breakdown is likely to occur between the conductor patterns. In the '752 Publication, dielectric breakdown is inhibited by providing a highly insulating non-magnetic part made of a mixture of glass and alumina between adjacent conductor patterns.

The presence of non-magnetic regions in a part of the magnetic base body reduces the effective permeability of the coil component including the magnetic base body. It is desirable that the magnetic base body included in the coil component has not only high insulation properties but also high effective permeability.

### SUMMARY

It is an object of the present disclosure to solve or alleviate at least part of the drawbacks mentioned above. In particular, an object of the present disclosure is to improve the insulation between conductor patterns without reducing the effective permeability in a coil component including a magnetic base body made of metal magnetic particles.

Other objects of the disclosure will be made apparent through the entire description in the specification. The inventions recited in the claims may also address any other drawbacks in addition to the above drawback. The various inventions disclosed herein may be collectively referred to as “the invention”.

A magnetic base body according to one embodiment includes: a coil conductor provided in the magnetic base body so as to extend around a coil axis; a first external electrode electrically connected to one end of the coil conductor; and a second external electrode electrically connected to another end of the coil conductor. The coil conductor includes a first conductor pattern and a second conductor pattern opposed to the first conductor pattern in a first direction along the coil axis. The magnetic base body includes a first region and a second region, the first region containing a plurality of metal magnetic particles, the second region containing composite oxide particles containing Fe, Ni, and Zn. The second region is located to interpose between the first conductor pattern and the second conductor pattern. The second region is magnetic and insulating.

### Advantageous Effects

According to the embodiments disclosed herein, it is possible to improve the insulation between conductor patterns without reducing the effective permeability in a coil component including a magnetic base body made of metal magnetic particles.

### BRIEF DESCRIPTION OF THE DRAWINGS

FIG. 1 is a perspective view schematically showing a coil component 1 according to one embodiment of the present disclosure.

FIG. 2 is an exploded perspective view of the coil component 1 shown in FIG. 1.

FIG. 3 is a perspective view schematically showing a magnetic film 11 included in the coil component 1.

FIG. 4 is a sectional view schematically showing a sectional surface of the coil component 1 of FIG. 1 cut along the LT plane.

FIG. 5 is a sectional view schematically showing the magnetic fluxes produced in the coil component 1 of FIG. 1.

FIG. 6 is a sectional view schematically showing a sectional surface of a coil component 101 according to another embodiment of the present disclosure, cut along the LT plane.

FIG. 7 is a sectional view schematically showing a sectional surface of a coil component 201 according to still another embodiment of the present disclosure, cut along the LT plane.

FIG. 8 is a perspective view schematically showing a magnetic film 11 included in the coil component 201.

FIG. 9 is a sectional view schematically showing a sectional surface of a coil component 301 according to yet another embodiment of the present disclosure, cut along the LT plane.

FIG. 10 is a sectional view schematically showing a sectional surface of a coil component 401 according to yet another embodiment of the present disclosure, cut along the LT plane.

FIG. 11 is a flow chart showing a process of manufacturing a coil component according to one embodiment of the present disclosure.

### DESCRIPTION OF THE PREFERRED EMBODIMENTS

Various embodiments of the disclosure will be described hereinafter with reference to the appended drawings. Throughout the drawings, the same components are denoted by the same reference numerals. For convenience of explanation, the drawings are not necessarily drawn to scale. The following embodiments of the present disclosure do not limit the scope of the claims. The elements included in the following embodiments are not necessarily essential to solve the problem addressed by the disclosure.

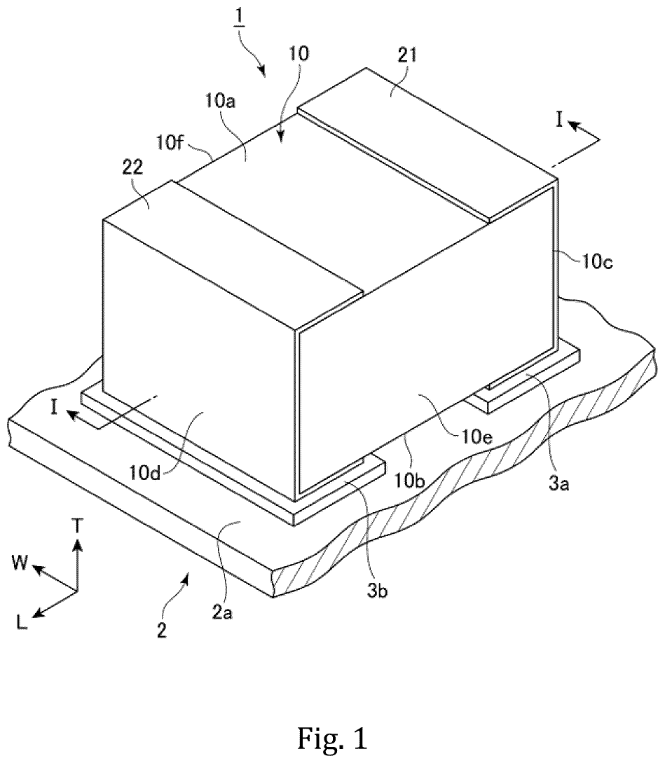

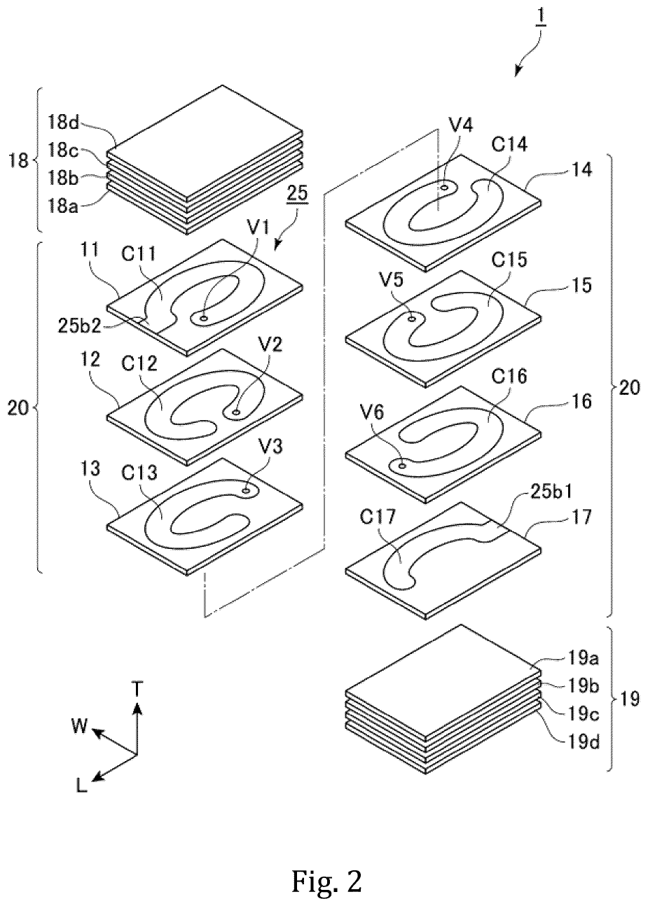

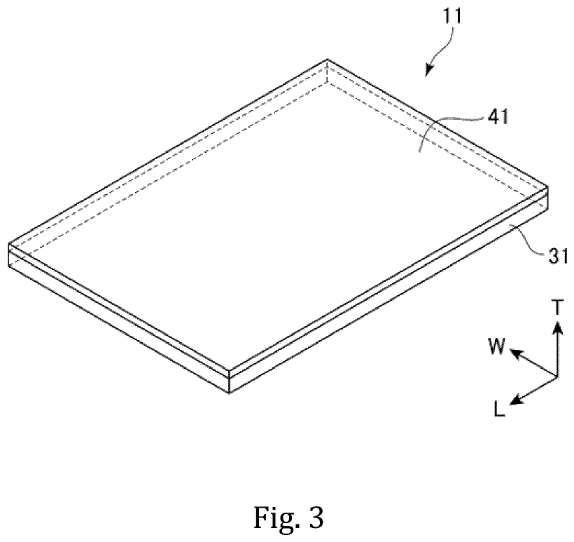

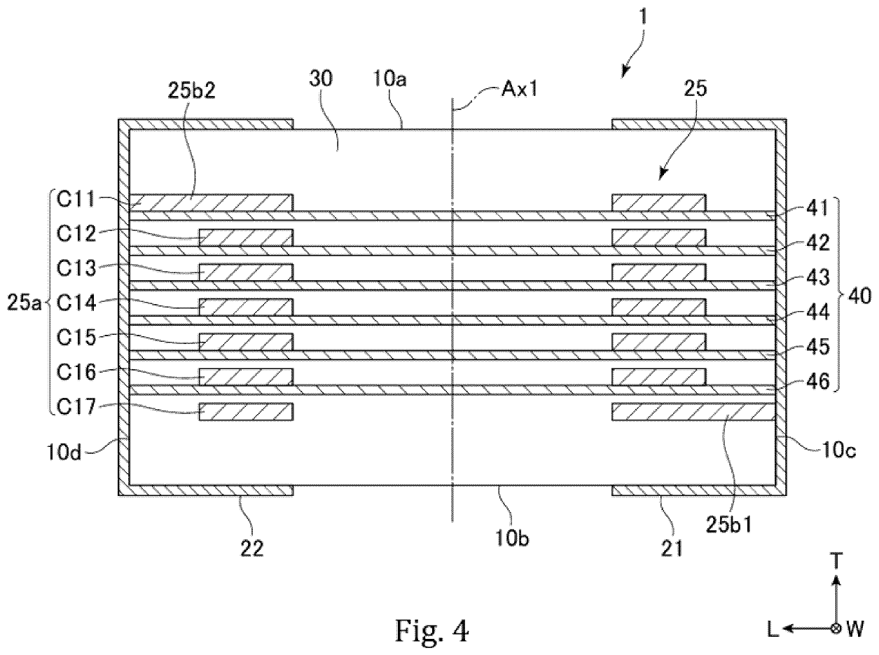

With reference to FIGS. 1 to 4, a description is first given of a coil component 1 according to one embodiment. FIG. 1 is a schematic perspective view of the coil component 1, and FIG. 2 is an exploded perspective view of the coil component 1. FIG. 3 is a perspective view schematically showing a magnetic film included in the coil component 1. FIG. 4 is a schematic sectional view of the coil component 1 along the line I-I of FIG. 1. In FIG. 2, external electrodes are not shown for convenience of description.

By way of one example of the coil component 1, FIGS. 1 to 4 show a laminated inductor and components thereof. The laminated inductor shown is an example of the coil component 1 to which the invention can be applied. The invention can also be applied to various coil components other than the laminated inductor. For example, the coil component 1 may be applied to wire-wound coil components or planar coils.

As shown in FIG. 1, the coil component 1 includes a magnetic base body 10, a first external electrode 21 disposed on a surface of the magnetic base body 10, and a second external electrode 22 disposed on the surface of the magnetic base body 10 at a position spaced apart from the first external electrode 21. Although not shown in FIG. 1, a coil conductor 25 is provided in the magnetic base body 10. The first external electrode 21 is electrically connected to one end of the coil conductor 25, and the second external electrode 22 is electrically connected to the other end of the coil conductor 25. The coil conductor 25 will be described later.

The coil component 1 may be mounted on a mounting substrate 2a. In the illustrated embodiment, the mounting substrate 2a has lands 3a and 3b provided thereon. The coil component 1 is mounted on the mounting substrate 2a by bonding the first external electrode 21 to the land 3a and bonding the second external electrode 22 to the land 3b. A circuit board 2 according to one embodiment of the present disclosure includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices. The coil component 1 may be built in to a substrate.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In one embodiment of the present disclosure, the magnetic base body 10 is configured such that the dimension in the L-axis direction (length dimension) is greater than the dimension in the W-axis direction (width dimension) and the dimension in the T-axis direction (height dimension). For example, the coil component 1 has a length dimension of 1.0 mm to 6.0 mm, a width dimension of 0.5 mm to 4.5 mm, and a height dimension of 0.5 mm to 4.5 mm. The dimensions of the magnetic base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the magnetic base body 10 are not limited to those specified herein.

The base body 10 has a first principal surface 10a, a second principal surface 10b, a first end surface 10c, a second end surface 10d, a first side surface 10e, and a second side surface 10f. The outer surface of the magnetic base body 10 is defined by these six surfaces. The first principal surface 10a and the second principal surface 10b are at the opposite ends in the height direction of the magnetic base body 10, the first end surface 10c and the second end surface 10d are at the opposite ends in the length direction of the magnetic base body 10, and the first side surface 10e and the second side surface 10f are at the opposite ends in the width direction of the magnetic base body 10. As shown in FIG. 1, the first principal surface 10a, which is at the top of the magnetic base body 10, may be herein referred to as a “top surface.” Likewise, the second principal surface 10b may be herein referred to as a “lower surface” or “bottom surface.” Since the coil component 1 is disposed such that the second principal surface 10b faces the mounting substrate 2a, the second principal surface 10b may be herein referred to as “the mounting surface.” The top surface 10a and the bottom surface 10b are separated from each other by a distance equal to the height of the magnetic base body 10, the first end surface 10c and the second end surface 10d are separated from each other by a distance equal to the length of the magnetic base body 10, and the first side surface 10e and the second side surface 10f are separated from each other by a distance equal to the width of the magnetic base body 10.

As shown in FIG. 2, the magnetic base body 10 includes a body layer 20, a bottom cover layer 19 provided on the bottom-side surface of the body layer 20, and a top cover layer 18 provided on the top-side surface of the body layer 20. The top cover layer 18, bottom cover layer 19, and body layer 20 are the components of the magnetic base body 10.

The body layer 20 includes magnetic films 11 to 17 made of a magnetic material. In the body layer 20, the magnetic films 17, 16, 15, 14, 13, 12 and 11 are stacked in the stated order from the negative side toward the positive side in the T-axis direction.

Each of the magnetic films 11 to 17 is a laminated sheet including: a first magnetic sheet containing a plurality of metal magnetic particles; and a second magnetic sheet formed on the top surface of the first magnetic sheet and containing a plurality of composite oxide particles containing Fe, Ni, and Zn. A further description is given of the laminated sheet with reference to the schematic view of the magnetic film 11 shown in FIG. 3. As shown in FIG. 4, the magnetic film 11 is a laminated sheet including: a first magnetic sheet 31 containing a plurality of metal magnetic particles; and a second magnetic sheet 41 formed on the top surface of the first magnetic sheet 31. Although not shown, each of the magnetic films 12 to 17 is also configured as a laminated sheet in the same manner as the magnetic film 11.

The magnetic films 11 to 17 have the conductor patterns C11 to C17, respectively, formed on the top-side surfaces thereof. The conductor patterns C11 to C17 each extend around a coil axis Ax1 (see FIG. 4) within a plane orthogonal to the coil axis Ax1 (the LW plane). The conductor patterns C11 to C17 are formed by, for example, printing a conductive paste made of a highly conductive metal or alloy via screen printing. The conductive paste is produced by mixing and kneading conductive powder made of conductive materials having excellent conductivity, such as Ag, Pd, Cu, Al or alloys of these, with a binder resin and a solvent. The binder resin may be PVB resins, phenolic resins, other resins known as binder resins, or mixtures thereof. When Cu powder is used as the conductive powder, a thermally decomposable resin such as acrylic resin may be used as the binder resin to prevent excessive oxidation of the Cu powder during degreasing. The conductive paste may contain modifiers for adjusting thixotropy. The conductor patterns C11 to C17 may be formed using other methods and materials. For example, the conductor patterns C11 to C17 may be formed by sputtering, ink-jetting, or other known methods.

The magnetic films 11 to 16 have vias V1 to V6, respectively, at a predetermined position therein. The vias V1 to V6 are formed by forming through holes at the predetermined positions in the magnetic films 11 to 16 so as to extend through the magnetic films 11 to 16 in the T-axis direction and filling the through holes with a conductive material. Each of the conductor patterns C11 to C17 is electrically connected to the respective adjacent conductor patterns in the direction along the T-axis through the vias V1 to V6.

The end of the conductor pattern C11 opposite to the end thereof connected to the via V1 is connected to the second external electrode 22. The end of the conductor pattern C17 opposite to the end thereof connected to the via V6 is connected to the first external electrode 21.

The top cover layer 18 includes magnetic films 18a to 18d made of a magnetic material, and the bottom cover layer 19 includes magnetic films 19a to 19d made of a magnetic material. In this specification of the present disclosure, the magnetic films 18a to 18d and the magnetic films 19a to 19d may be referred to collectively as “the cover layer magnetic films.” The components of the magnetic base body 10 do not necessarily have a lamination structure with a plurality of magnetic films stacked together. For example, the top cover layer 18 may be a compact formed of a magnetic material, rather than a laminate including a plurality of magnetic films 18a to 18d stacked together.

As shown in FIG. 4, the coil conductor 25 includes a winding portion 25a wound around the coil axis Ax1 extending along the thickness direction (T-axis direction), a lead-out portion 25b1 that extends from one end of the winding portion 25a to the first end surface 10c of the magnetic base body 10, and a lead-out portion 25b2 that extends from the other end of the winding portion 25a to the second end surface 10d of the magnetic base body 10. The conductor patterns C11 to C17 and the vias V1 to V6 form the winding portion 25a having a spiral shape. In other words, the winding portion 25a is constituted by the conductor patterns C11 to C17 and the vias V1 to V6.

The magnetic base body 10 is partitioned into a plurality of regions. The plurality of regions constituting the magnetic base body 10 include a first region 30 and a second region 40. Both the first region 30 and the second region 40 are insulating and magnetic, but these are made of different magnetic materials. Due to the difference of magnetic materials, the first region 30 and the second region 40 are different in volume resistivity and magnetic permeability. Specifically, the second resistivity, which indicates the volume resistivity of the second region 40, is larger than the first resistivity, which indicates the volume resistivity of the first region 30. The second permeability, which indicates the magnetic permeability of the second region 40, is larger than the first permeability, which indicates the magnetic permeability of the first region 30.

In one embodiment, the magnetic permeability of the first region 30 is in the range of 20 to 60, and the magnetic permeability of the second region is in the range of 30 to 100. The magnetic permeabilities of the first region 30 and the second region 40 can be measured using commercially available analyzers. The magnetic permeabilities of the first region 30 and the second region 40 can be measured, for example, using the impedance material analyzer E4991A from Agilent. The magnetic permeabilities measured at a frequency of 100 kHz can be used as the magnetic permeabilities of the first region 30 and the second region 40.

In one embodiment, the volume resistivity of the first region 30 is in the range of 10⁵ to 10⁸ Ω·cm, and the volume resistivity of the second region 40 is equal to or larger than 10⁷ Ω·cm. However, as mentioned above, the volume resistivity of the second region 40 is larger than that of the first region 30. The volume resistivities of the first region 30 and the second region 40 can be measured in conformity to JIS-K6911.

The second region 40 is disposed between adjacent ones of the plurality of conductor patterns constituting the coil conductor 25. For example, in the embodiment shown in FIG. 4, the second magnetic sheet 41, which constitutes a part of the second region 40, is provided between the conductor patterns C11 and C12. The second magnetic sheets 42, 43, 44, 45, and 46 are also provided between other adjacent ones of conductor patterns. The second magnetic sheets 41 to 46 constitute the second region 40. Each of the second magnetic sheets 41 to 46 is provided between adjacent ones of the conductor patterns. In other words, adjacent ones of the conductor patterns are disposed to sandwich one of the second magnetic sheets 41 to 46.

In the embodiment shown in FIG. 4, each of the second magnetic sheets 41 to 46 is disposed in contact with corresponding one of the conductor patterns C11 to C16. For example, the second magnetic sheet 41 is in contact with the conductor pattern C11.

In the embodiment shown in FIG. 2, each of the second magnetic sheets 41 to 46 extends from one end to the other end of the base body in the L-axis. The second magnetic sheets 41 to 46 are thus exposed from the first end surface 10c and the second end surface 10d of the base body 10. Each of the second magnetic sheets 41 to 46 may extend from one end to the other end of the base body 10 in the W-axis. In this case, the second magnetic sheets 41 to 46 are also exposed from the first side surface 10e and the second side surface 10f of the base body 10. Each of the second magnetic sheets 41 to 46 is disposed in contact with the bottom surface of corresponding one of the conductor patterns C11 to C17. For example, the second magnetic sheet 41 is in contact with the bottom surface of the conductor pattern C11. To ensure insulation between adjacent conductor patterns, each of the second magnetic sheets 41 to 46 should preferably be configured and disposed to cover the entire bottom surface of corresponding one of the conductor patterns.

In the coil component 1, the second region 40 having a higher magnetic permeability and volume resistivity than the first region 30 is disposed between adjacent conductor patterns in the T-axis direction, and the second region 40 improves the insulation between adjacent conductor patterns without reducing the effective magnetic permeability of the coil component 1. Further, in the coil component 1, the improved insulation between the conductor patterns allows a smaller distance between the conductor patterns without causing dielectric breakdown. Thus, the coil component 1 can have a smaller dimension in the T-axis direction.

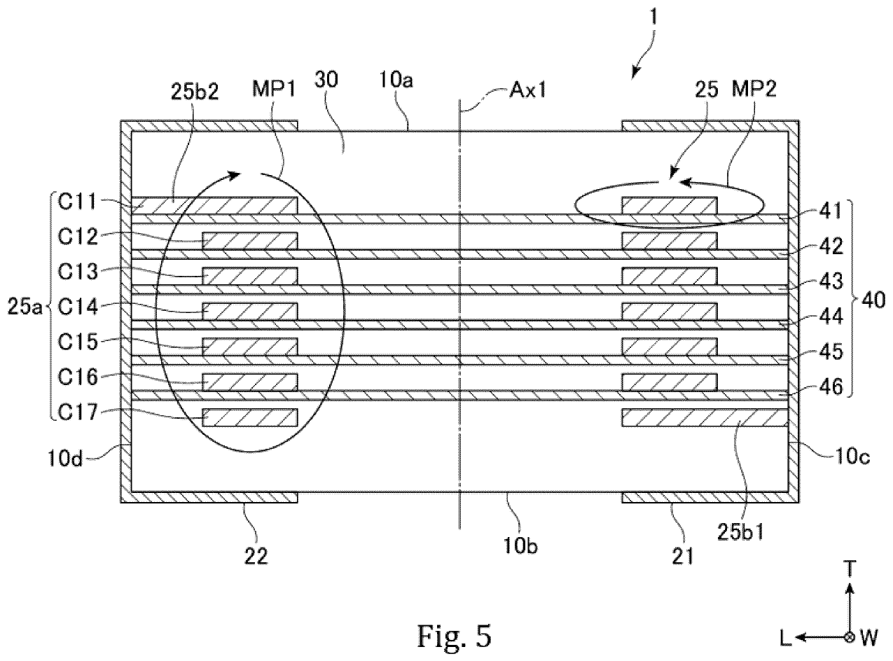

In an aspect of the present disclosure, the thickness (the dimension in the T-axis direction) of each of the second magnetic sheets 41 to 46 should preferably be 3 μm or smaller. In the coil component 1, the second region 40 having a high volume resistivity is interposed between adjacent conductor patterns, and thus the intervals between adjacent conductor patterns can be smaller. Therefore, the thickness of the second region 40 in the T-axis direction can also be smaller. With the dimension of the second magnetic sheets 41 to 46 in the T-axis direction set to 3 μm or smaller, the intervals between the conductor patterns can be smaller, thus increasing the magnetic resistance in the region between the conductor patterns. As shown in FIG. 5, the increased magnetic resistance between the conductor patterns allows more magnetic flux to pass through the main magnetic path MP1 and less magnetic flux to pass through the magnetic path MP2 between the conductor patterns. Thus, the coil component 1 can have a further improved effective permeability.

The first region 30 refers to a part or entirety of the region of the magnetic base body 10 other than the second region 40. The magnetic base body 10 may be constituted only by the first region 30 and the second region 40, or may have a region other than the first region 30 and the second region 40.

The first region 30 contains a plurality of metal magnetic particles. The metal magnetic particles are made of a soft magnetic material composed mainly of Fe. The metal magnetic particles contain Si as an additive element in addition to Fe. The metal magnetic particles may contain at least one of Cr and Al in addition to Fe and Si. The metal magnetic particles may contain additive elements other than those mentioned above. The Fe content in the metal magnetic particles may be 94 wt % or larger. The Si content in the metal magnetic particles may be 3 wt % or larger. The Cr content in the metal magnetic particles may be equal to or larger than 1 wt % and less than 3 wt %. The Al content in the metal magnetic particles may be equal to or larger than 1 wt % and less than 3 wt %.

The average particle size of the metal magnetic particles contained in the first region 30 is, for example, 1 to 20 μm. The average particle size of the metal magnetic particles contained in the magnetic base body 10 may be 1 to 10 μm or may be 2 to 8 μm.

The surface of each of the metal magnetic particles contained in the first region 30 is covered by an insulating film having excellent insulation properties. Thus, the metal magnetic particles contained in the magnetic base body 10 are electrically insulated from each other. In the first region 30, each metal magnetic particle is bonded to adjacent metal magnetic particles via the insulating films provided on their respective surfaces. In other words, the insulating films provided on the surfaces of adjacent metal magnetic particles are bonded to each other, and this bonding of the insulating films forms bonding of the metal magnetic particles covered by the insulating films.

The metal magnetic particles contained in the first region 30 of the magnetic base body 10 are produced, for example, by heating a magnetic powder made of a soft magnetic material. The insulating films provided on the surfaces of the metal magnetic particles may be oxide films produced when the raw magnetic powder is heated, or may be coating films applied to the surfaces of the raw magnetic powder. The coating films may be thin films composed mainly of silica or glass.

Each of the second magnetic sheets 41 to 46 constituting the second region 40 contains composite oxide particles containing Fe, Ni, and Zn. The second region 40 may contain an amount of additive element smaller than those of Fe, Ni, and Zn on a mass basis. At least one element selected from the group consisting of Cu, Mn, Bi, Si, and Sn can be contained in the second region 40 as an additive element.

The second region 40 is formed, for example, by the following method. First, powders of Fe₂O₃, NiO, and ZnO are mixed, and the mixed powder thus obtained is calcined at about 850° C. Next, the calcined mixed powder is crushed by a wet crusher to obtain a mixed oxide powder having an average particle size of 0.05 to 3 μm. Next, the mixed oxide powder is mixed with water to prepare a magnetic material paste, and this slurry is formed into a sheet to produce a sheet compact. The sheet compact is heated, for example, in the temperature range in which a ferrite reaction occurs in the mixed oxide powder (e.g., 800 to 1000° C.), thus forming the second magnetic sheets 41 to 46. The second magnetic sheets 41 to 46 thus formed contain composite oxide particles containing Fe, Ni, and Zn. As described in detail later, the first region 30 and the second region 40 (second magnetic sheets 41 to 46) may be formed simultaneously by stacking a sheet compact containing the mixed oxide powder on top of a sheet compact containing raw powder of metal magnetic particles to form a laminate, and then heating the laminate.

The oxides Fe₂O₃, NiO, and ZnO, which are the raw powders for the composite oxide particles contained in the second region 40, and the composite oxides containing Fe, Ni, and Zn all have high insulation properties. Thus, the second region 40 has high insulation properties. In addition, since the ferrite reaction occurs during the formation of composite oxide particles from the raw powder, the composite oxide particles are magnetic. Therefore, all of the second magnetic sheets 41 to 46 containing such composite oxide particles exhibit magnetism and have high insulation properties.

During the heat treatment for forming the first region 30 and the second region 40, at the contact point between the magnetic powder, or the raw material for the first region 30, and the mixed oxide powder, or the raw material for the second region 40, ZnCr₂O₄ is formed by oxidation of both Cr in the magnetic powder and Zn in the mixed oxide powder. Therefore, in the base body 10, the interface between the first region 30 and the second region 40 contains ZnCr₂O₄. Since the magnetic base body 10 contains ZnCr₂O₄ at the interface between the first region 30 and the second region 40, the metal magnetic particles in the first region 30 and the composite oxide in the second region 40 are bonded by ZnCr₂O₄. This allows the first region 30 and the second region 40 to be firmly bonded. When the magnetic powder contains Al, ZnAl₂O₄ is formed at the interface between the first region 30 and the second region 40. ZnAl₂O₄ also strengthens the bond between the first region 30 and the second region 40.

The average particle size of the mixed oxide powder used to form the second region 40 should preferably be less than 1 μm. For example, the average particle size of the mixed oxide powder can be 50 to 300 nm. A smaller average particle size of the mixed oxide powder increases the contact points between the raw powder for the metal magnetic particles and the mixed oxide powder, thereby promoting the formation of ZnCr₂O₄ and ZnAl₂O₄ at the interface between the first region 30 and second region 40.

The average particle size of the composite oxide particles in the second region 40 is the same as the average particle size of the mixed oxide powder, or the raw powder for the composite oxide particles. For example, the average particle size of the composite oxide particles in the second region 40 can be 0.05 to 3 μm. As mentioned above, the composite oxide particles in the second region 40 are produced by heating the mixed oxide powder, or the raw powder, to a temperature of 800 to 1000° C., which is lower than the common sintering temperature for Ni—Zn ferrite of 1100 to 1400° C. At a heating temperature of 800 to 1000° C., ferrite reactions occur to form composite oxide particles containing Fe, Ni, and Zn, but little or no grain growth of the composite oxide particles occurs. Therefore, the average particle size of the composite oxide particles is the same as the average particle size of the mixed oxide powder, or the raw powder for the composite oxide particles. When the difference between the average particle size of the composite oxide particles and the average particle size of the mixed oxide powder is within 20% of the average particle size of the mixed oxide powder, it can be determined that the average particle size of the composite oxide particles is the same as that of the mixed oxide powder. Both the average particle size of the mixed oxide powder and the average particle size of the composite oxide in the second region 40 can be measured using a scanning electron microscope (SEM). To measure the average particle size of the mixed oxide powder, the prepared mixed oxide powder is placed on an SEM sample stand, and an SEM image of the mixed oxide powder on the sample stand is taken at a magnification of about 10,000 to 50,000 times. To measure the average particle size of the composite oxide, the base body 10 is cut or ground along its thickness direction (T-axis direction) to expose a sectional surface, and an SEM image of the region corresponding to the second region 40 in the sectional surface is taken by SEM at a magnification of about 10,000 to 50,000 times. Next, in each of the SEM image of the mixed oxide powder and the SEM image of the sectional surface of the base body 10, the equivalent circle diameter (Haywood diameter) of each powder and each mixed oxide particle constituting the mixed oxide powder is determined by image analysis. The average value of the equivalent circle diameters of the mixed oxide powder in the SEM image can then be taken as the average particle size of the mixed oxide powder, and the average value of the equivalent circle diameter of each composite oxide particle can be taken as the average particle size of the composite oxide particles.

In a sectional surface of the coil component 1 cut along a cutting plane extending in the direction along the T-axis (e.g., a sectional surface along the LT plane, as shown in FIG. 4), the area occupied by the second region 40 is 1% to 10% of the total area of the sectional surface. The second region 40, which contains composite oxide particles containing Fe, Ni, and Zn, is more susceptible to magnetic saturation than the first region 30, which contains metal magnetic particles. Therefore, if the proportion occupied by the second region 40 in the magnetic base body 10 increases, the magnetic saturation characteristics of the magnetic base body 10 may deteriorate. In one aspect of the present disclosure, the area occupied by the second region 40 is 10% or smaller, such that the insulation between the conductor patterns can be improved without degrading the effective permeability by the second region 40, and the magnetic saturation characteristics of the magnetic base body 10 can be inhibited from deteriorating. The upper limit for the second region 40 may be 5% of the sectional surface area of the base body 10.

The shape and arrangement of the second region 40 shown in FIG. 4 is an example. The shape and arrangement of the second region 40 are not limited to those shown in FIG. 4. The second region 40 can have any shape and arrangement that allow the second region 40 to be interposed between adjacent conductor patterns to improve insulation between those conductor patterns. The following describes variations of the second region 40 with reference to FIGS. 5 to 8.

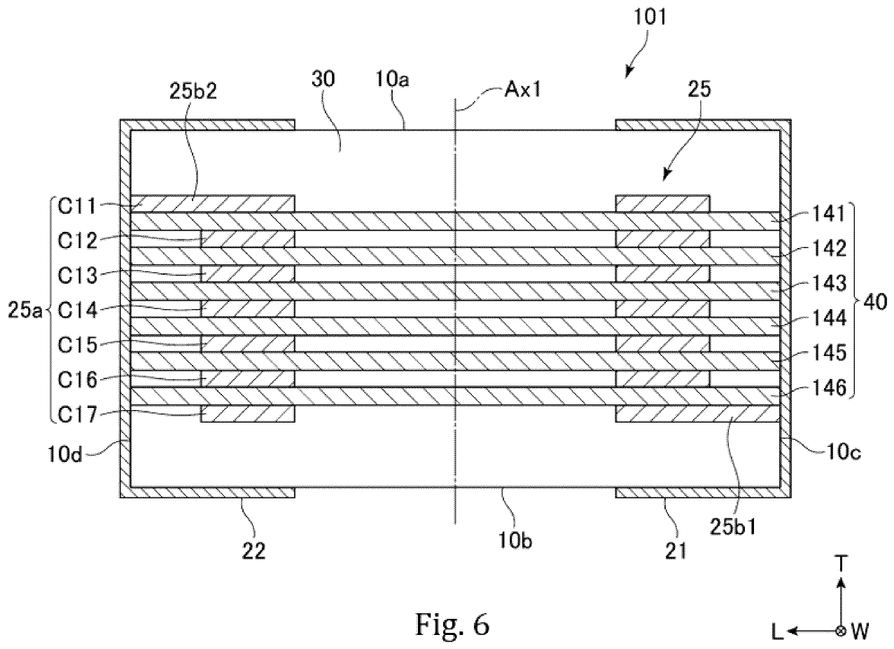

First, with reference to FIG. 6, a description is given of a coil component 101 according to another embodiment of the disclosure. FIG. 6 is a sectional view of the coil component 101 cut along the LT plane. The coil component 101 differs from the coil component 1 in that the second region 40 includes second magnetic sheets 141 to 146 instead of the second magnetic sheets 41 to 46.

Each of the second magnetic sheets 141 to 146 extends over the entire region between adjacent ones of the conductor patterns in the T-axis direction. In other words, each of the second magnetic sheets 141 to 146 is disposed to contact both adjacent conductor patterns in the T-axis direction. For example, the second magnetic sheet 141 is in contact with both the conductor patterns C11 and C12 adjacent to each other, and extends from the conductor pattern C11 to the conductor pattern C12 along the T-axis direction.

In the coil component 101, the entire region between adjacent conductor patterns is occupied by the second region 40 having higher insulation than the first region 30, and therefore, the insulation between adjacent conductor patterns can be further improved.

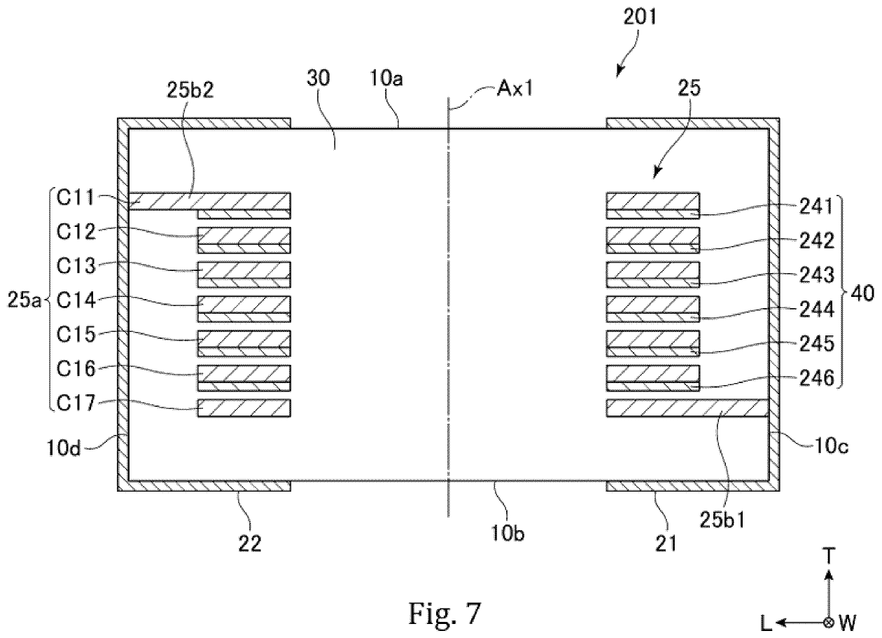

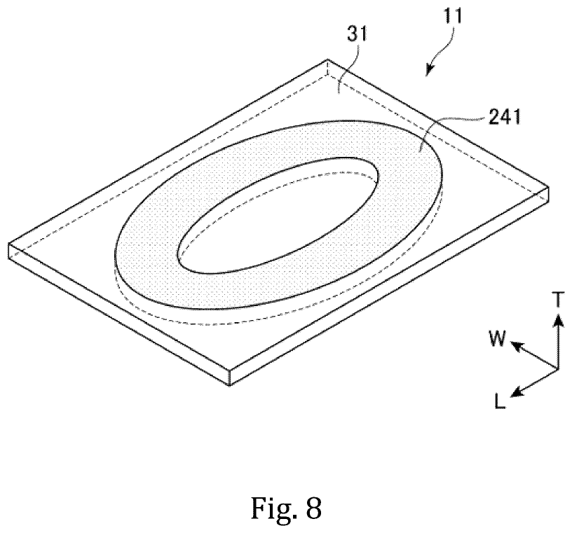

Next, with reference to FIGS. 7 and 8, a description is given of a coil component 201 according to still another embodiment of the present disclosure. FIG. 7 is a sectional view of the coil component 201 cut along the LT plane, and FIG. 8 is a perspective view of the magnetic film 11 provided in the coil component 201. The coil component 201 differs from the coil component 101 in that the second region 40 includes second magnetic sheets 241 to 246 instead of the second magnetic sheets 141 to 146.

Each of the second magnetic sheets 241 to 246 has a ring-like shape extending around the coil axis Ax1 within a plane orthogonal to the coil axis Ax1 (the LW plane). Each of the second magnetic sheets 241 to 246 is positioned to overlap with corresponding one of the conductor patterns C11 to C16 in plan view. Each of the second magnetic sheets 241 to 246 has the same width as corresponding one of the conductor patterns C11 to C16 in plan view. For example, as shown in FIG. 8, the magnetic film 11 included in the magnetic base body 10 is a laminated sheet constituted by the first magnetic sheet 31 and a ring-shaped second magnetic sheet 241 formed in the top surface of the first magnetic sheet 31. The first magnetic sheet 31 has a rectangular shape. The second magnetic sheet 241 has the same ring-like shape as the conductor pattern C11 in plan view. The second magnetic sheet 241 may extend for one circumference around the coil axis Ax1, as shown in FIG. 8, or it may extend only for the region overlapping with the conductor pattern C11 in the circumferential direction around the coil axis Ax1. Since the conductor pattern C11 is partly cut in the circumferential direction, as shown in FIG. 2, the second magnetic sheet 241 may also be cut at the same location as the conductor pattern C11. The above description for the second magnetic sheet 241 also applies to the other second magnetic sheets (second magnetic sheets 242 to 246).

In the coil component 201, the proportion of the area occupied by the second region 40 in the sectional surface of the magnetic base body 10 can be smaller than in the coil components 1 and 101. Therefore, the coil component 201 has better magnetic saturation characteristics than the coil components 1 and 101.

In the embodiment shown in FIG. 7, the second magnetic sheets 241 to 246 are in contact with only one of the adjacent conductor patterns, but the second magnetic sheets 241 to 246 may be in contact with both of the adjacent conductor patterns.

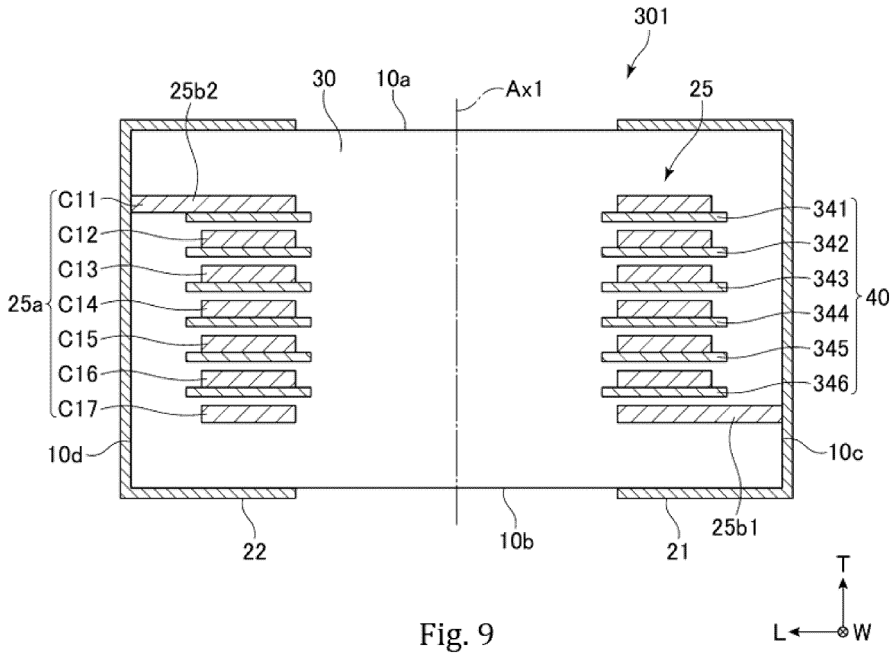

Next, with reference to FIG. 9, a description is given of a coil component 301 according to yet another embodiment of the present disclosure. FIG. 9 is a sectional view of the coil component 301 cut along the LT plane. The coil component 301 differs from the coil component 201 in that the second region 40 includes second magnetic sheets 341 to 346 instead of the second magnetic sheets 241 to 246.

As shown in FIG. 9, each of the second magnetic sheets 341 to 346 is configured to have a larger width than corresponding one of the conductor patterns in plan view (as viewed from the T-axis direction). Thus, the area of each of the second magnetic sheets 341 to 346 in plan view is larger than the area of corresponding one of the conductor patterns. For example, the area of the second magnetic sheet 341 in plan view is larger than the area of the conductor pattern C11 in plan view.

In the coil component 301, each of the second magnetic sheets 341 to 346 has a larger area than corresponding one of the conductor patterns, and therefore, the insulation between adjacent conductors can be further improved.

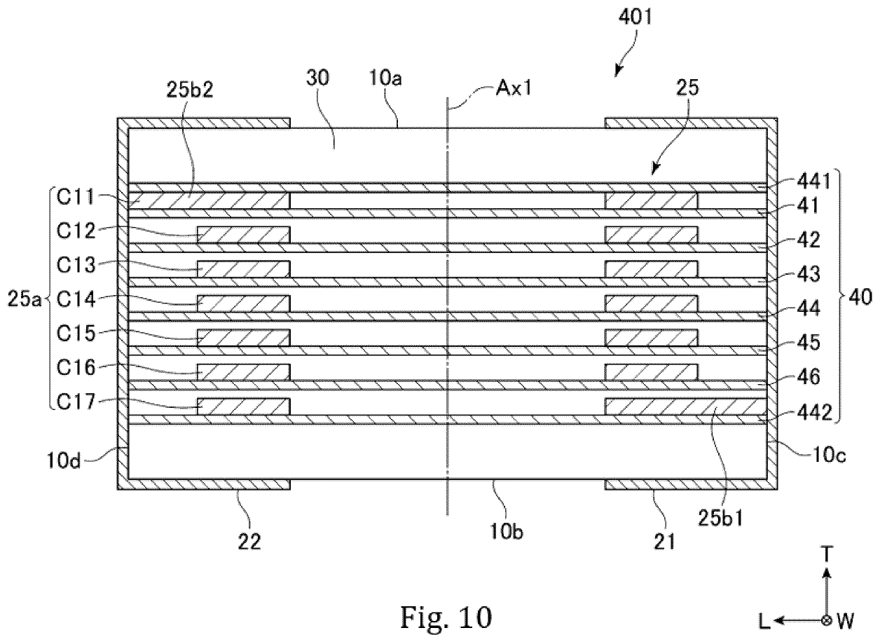

Next, with reference to FIG. 10, a description is given of a coil component 401 according to yet another embodiment of the present disclosure. FIG. 10 is a sectional view of the coil component 401 cut along the LT plane. The coil component 401 differs from the coil component 1 in that the second region 40 additionally includes second magnetic sheets 441 and 442.

As shown in FIG. 10, the second magnetic sheet 441 is provided between the conductor pattern C11 and the portion of the first external electrode 21 that is in contact with the top surface 10a of the magnetic base body 10, and between the conductor pattern C11 and the portion of the second external electrode 22 that is in contact with the top surface 10a of the magnetic base body 10. The second magnetic sheet 442 is provided between the conductor pattern C17 and the portion of the first external electrode 21 that is in contact with the bottom surface 10b of the magnetic base body 10, and between the conductor pattern C17 and the portion of the second external electrode 22 that is in contact with the bottom surface 10b of the magnetic base body 10.

In the coil component 401, the second magnetic sheets 441 and 442 can inhibit dielectric breakdown in the magnetic base 10 occurring in the regions between the conductor patterns and the first and second external electrodes 21 and 22.

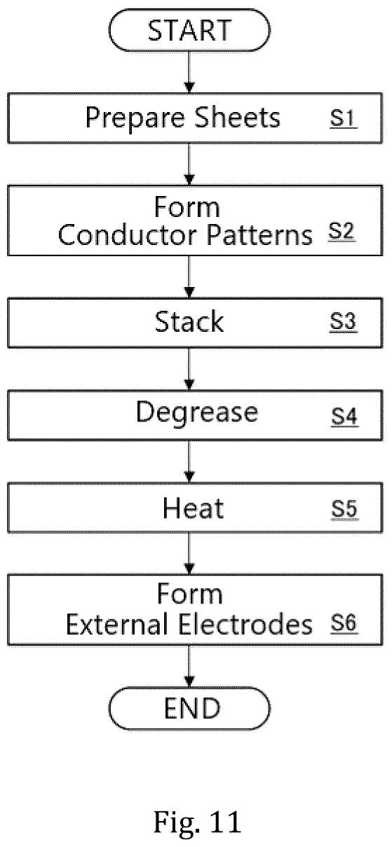

Next, one example of a manufacturing method of the coil component 1 will be described with reference to FIG. 11. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

First, in step S1, green laminated sheets, which are precursors of the magnetic films (the magnetic films 11 to 17), are prepared. The green laminated sheets are each formed by stacking two layers of sheets. Specifically, the green laminated sheets are each formed of a green first magnetic sheet, which is the precursor of the first magnetic sheet, and a green second magnetic sheet, which is the precursor of the second magnetic sheet.

The precursor of the first magnetic sheet is produced from a first magnetic material paste which is obtained by mixing and kneading magnetic powder (raw powder), which is the raw material of the metal magnetic particles, with a binder resin and a solvent. The magnetic powder, or the raw powder, is formed of a soft magnetic metal material. The magnetic powder contains Fe and Si. The magnetic powder may contain at least one of Cr and Al in addition to Fe and Si. In the following description of the manufacturing method, it is assumed for clarity of description that the magnetic powder, or the raw powder, contains Fe, Si, and Cr. The magnetic material paste is applied to the surface of a plastic base film by the doctor blade method or other common methods. The magnetic material paste applied to the surface of the base film is dried to obtain sheet-shaped compacts. A molding pressure of approximately 10 MPa to 100 MPa is applied for molding to the sheet-shaped compacts in a mold, so that a plurality of green first magnetic sheets are produced.

The green second magnetic sheet is produced from a second magnetic material paste obtained by mixing and kneading a mixed oxide powder, which is the raw powder for the composite oxide particles, with water. The mixed oxide powder is prepared by calcining Fe₂O₃, NiO, and ZnO powders at about 850° C. and then crushing the calcined mixed powders by a wet crusher. The mixed oxide powder is crushed to an average particle size of 0.05 to 3 μm. Next, the mixed oxide powder is mixed with water to prepare a slurry, and this slurry is formed into sheets to produce green second magnetic sheets.

Next, the green first magnetic sheets and the green second magnetic sheets prepared as described above are stacked in pairs to form green laminated sheets.

Next, in step S2, a conductive paste is applied to the plurality of green laminated sheets prepared in step S1. The conductive paste is applied to the top surface of the green second magnetic sheet in the green laminate sheet so as to cover at least a part of the green second magnetic sheet. The conductive paste is produced by mixing and kneading conductive powder made of conductive materials having excellent conductivity, such as Ag, Pd, Cu, Al or alloys of these, with a binder resin and a solvent. The conductive paste applied to the green laminated sheets forms unfired conductor patterns on the green laminated sheets. The unfired conductor patterns will be the conductor patterns C11 to C16 after firing. The conductive paste is also applied to the green first magnetic sheet that is not stacked together with the green second magnetic sheet. The conductive paste applied to this green first magnetic sheet will be the conductor pattern C17 after firing.

Each of the green laminated sheets has a through hole extending therethrough in the lamination direction. These through holes are filled with the conductive paste. In this way, unfired via conductors are formed in the through holes of the magnetic sheets, and these unfired via conductors will be via conductors V1 to V6 after firing. The conductive paste is applied to the green laminated sheets and the green first magnetic sheet by, for example, screen printing.

Next, in step S3, the green laminated sheets and the green first magnetic sheet having the conductive paste applied thereto are stacked together to form an intermediate laminate that will be the body layer 20 after firing. Also, the green first magnetic sheets are stacked together to produce a top laminate, which will be the top cover layer 18 after firing, and a bottom laminate, which will be the bottom cover layer 19 after firing. The green first magnetic sheets constituting the top laminate will be the magnetic films 18a to 18d in the finished coil component 1, and the green first magnetic sheets constituting the bottom laminate will be the magnetic films 19a to 19d in the finished coil component 1. The six green laminated sheets and one green first magnetic sheet that constitute the intermediate laminate will be the magnetic films 11 to 17 in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced by a cutter such as a dicing machine or a laser processing machine to obtain a chip laminate. The chip laminate is an example of a compact that includes an element body to be the magnetic base body 10 after the heat treatment and unfired conductor patterns to be the coil conductor 25 after the heat treatment. The compact that includes the element body to be the magnetic base body 10 after the heat treatment and the unfired conductor patterns to be the coil conductor 25 after the heat treatment may be fabricated by a method other than the sheet lamination method.

Next, in step S4, the compact fabricated in step S3 is degreased. The degreasing process for the compact may be performed in a non-oxygen atmosphere such as a nitrogen atmosphere. By performing the degreasing process in a non-oxygen atmosphere, the oxidation of Fe contained in the raw powder can be prevented during the degreasing process. The degreasing process is performed at a temperature of 300° C. to 500° C. for a duration of 30 to 60 minutes, for example. Since the degreasing process decomposes the thermally decomposable resin contained in the compact, no thermally decomposable resin remains in the compact after the degreasing process is completed. When the binder resin for the conductive paste is the same thermally decomposable resin as the binder resin for the magnetic material paste, the binder resin contained in the unfired conductor patterns is also thermally decomposed during the degreasing process in step S4. Thus, in step S4, all of the green first magnetic sheets, the green second magnetic sheets, and the unfired conductor patterns constituting the compact are degreased.

The degreased compact is then subjected to heat treatment in step S5. The heat treatment is performed in the air at a temperature of 800° C. to 1000° C. for a duration of 1 to 6 hours. The heat treatment in step S5 may be performed in a low oxygen concentration atmosphere containing oxygen of 5 to 10,000 ppm.

In this heat treatment, an insulating oxide film is formed on the surface of the magnetic powder contained in the green first magnetic sheets by oxidation of the elements contained in the magnetic powder. Thus, the first region 30, which contains a plurality of metal magnetic particles bonded to each other via insulating films, is formed from the green first magnetic sheets.

In the heat treatment of step S5, a ferrite reaction occurs in the mixed oxide powder contained in the green second magnetic sheets. Thus, the second region 40 (second magnetic sheets 41 to 46), which contains composite oxide particles containing Fe, Ni, and Zn is formed from the green second magnetic sheets.

Furthermore, in the heat treatment of step S5, ZnCr₂O₄ is formed at the interfaces between the green first magnetic sheets and the green second magnetic sheets. ZnCr₂O₄ thus formed firmly bonds the first region 30 formed from the green first magnetic sheets and the second region 40 formed from the green second magnetic sheets.

The heat treatment in step S5 causes the above reactions in the compact. As a result of this heat treatment, the magnetic base body 10 is obtained from the compact.

Furthermore, the heat treatment of step S5 also causes sintering of the conductive powder in the unsintered conductor patterns. The coil conductor 25 is obtained by sintering the conductive powder in the unsintered conductor patterns. When copper powder is used as the conductive powder, the copper crystals sinter densely to form the coil conductor 25. The heat treatment is performed at a temperature lower than the melting point of the metal (Cu or Ag) used as the material for the conductive powder. When Ag is used as the conductive powder, the heating temperature in step S5 is 800 to 950° C.

Next, in step S6, the first external electrode 21 and the second external electrode 22 are formed on the surface of the magnetic base body 10 obtained in step S5. The first external electrode 21 is connected to one end of the coil conductor 25, and the second external electrode 22 is connected to the other end of the coil conductor 25. The compact having gone through the heat treatment may be impregnated with a resin before the first and second external electrodes 21 and 22 are formed. The compact is impregnated with, for example, a thermosetting resin such as an epoxy resin. This allows the resin to penetrate the gaps between the metal magnetic particles in the magnetic base body 10. The resin that has penetrated into the magnetic base body 10 may be set to increase the mechanical strength of the magnetic base body 10.

The coil component 1 is fabricated through the steps described above.

The dimensions, materials, and arrangements of the constituent elements described for the above various embodiments are not limited to those explicitly described for the embodiments, and these constituent elements can be modified to have any dimensions, materials, and arrangements within the scope of the present disclosure.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### Additional Embodiment 1

A coil component comprising:
a magnetic base body (10);
a coil conductor (25) provided in the magnetic base body so as to extend around a coil axis (Ax1);
a first external electrode (21) electrically connected to one end of the coil conductor; and
a second external electrode (22) electrically connected to another end of the coil conductor,
wherein the coil conductor includes a first conductor pattern (C13) and a second conductor pattern (C14) opposed to the first conductor pattern in a first direction along the coil axis, and
wherein the magnetic base body includes a first region (30) and a second region (40), the first region containing a plurality of metal magnetic particles, the second region containing composite oxide particles containing Fe, Ni, and Zn, the second region being magnetic and insulating and being located to interpose between the first conductor pattern and the second conductor pattern.

### Additional Embodiment 2

The coil component of Additional Embodiment 1, wherein a second resistivity indicating a volume resistivity of the second region is larger than a first resistivity indicating a volume resistivity of the first region.

### Additional Embodiment 3

The coil component of Additional Embodiment 1 or 2, wherein a second permeability indicating a magnetic permeability of the second region is larger than a first permeability indicating a magnetic permeability of the first region.

### Additional Embodiment 4

The coil component of any one of Additional Embodiments 1 to 3, wherein a dimension of the second region in the first direction is 3 μm or smaller.

### Additional Embodiment 5

The coil component of any one of Additional Embodiments 1 to 4,
wherein a bottom surface of the first conductor pattern is opposed to a top surface of the second conductor pattern, and
wherein the second region covers an entirety of the bottom surface of the first conductor pattern.

### Additional Embodiment 6

The coil component of any one of Additional Embodiments 1 to 5, wherein an end of the second region is exposed from the magnetic base body.

### Additional Embodiment 7

The coil component of any one of Additional Embodiments 1 to 6, wherein the second region is in contact with at least the first conductor pattern.

### Additional Embodiment 8

The coil component of Additional Embodiment 7, wherein the second region is in contact with both the first conductor pattern and the second conductor pattern.

### Additional Embodiment 9

The coil component of any one of Additional Embodiments 1 to 8, wherein as viewed from a direction of the coil axis, an area of the second region is larger than both an area of the first conductor pattern and an area of the second conductor pattern.

### Additional Embodiment 10

The coil component of any one of Additional Embodiments 1 to 9,
wherein the plurality of metal magnetic particles contain Cr, and
wherein the magnetic base body contains ZnCr₂O₄ at an interface between the first region and the second region.

### Additional Embodiment 11

The coil component of any one of Additional Embodiments 1 to 10, wherein in a sectional surface of the magnetic base body cut along a cutting plane passing through the coil axis, an area occupied by the second region is 1% to 10% of an area of the sectional surface.

### Additional Embodiment 12

The coil component of any one of Additional Embodiments 1 to 11, wherein the second region is also located between the second conductor pattern and the first external electrode and between the second conductor pattern and the second external electrode.

### Additional Embodiment 13

A method of manufacturing a coil component, comprising the steps of:
forming a plurality of laminated sheets each including a green first magnetic sheet and a green second magnetic sheet, the green first magnetic sheet containing a magnetic powder, the green second magnetic sheet covering at least a part of a top surface of the green first magnetic sheet and containing Fe₂O₃ powder, ZnO powder, and NiO powder;
forming a conductor pattern on a top surface of each of the plurality of laminated sheets so as to cover at least a part of the green second magnetic sheet;
stacking the plurality of laminated sheets to form a laminate;
heating the laminate to form a magnetic base body; and
providing an external electrode on the magnetic base body.

### Additional Embodiment 14

The method of Additional Embodiment 13, wherein the laminate is heated at a temperature of 800° C. to 1000° C.

### Additional Embodiment 15

The method of Additional Embodiment 13 or 14, wherein in the step of heating, ZnCr₂O₄ is produced at an interface between the green first magnetic sheet and the green second magnetic sheet.

What is claimed is:

1. A coil component comprising:
a magnetic base body;
a coil conductor provided in the magnetic base body so as to extend around a coil axis;
a first external electrode electrically connected to one end of the coil conductor; and
a second external electrode electrically connected to another end of the coil conductor,
wherein the coil conductor includes a first conductor pattern and a second conductor pattern opposed to the first conductor pattern in a first direction along the coil axis, and
wherein the magnetic base body includes a first region and a second region, the first region containing a plurality of metal magnetic particles, the second region containing composite oxide particles containing Fe, Ni, and Zn, the second region being magnetic and insulating and being located to interpose between the first conductor pattern and the second conductor pattern.

2. The coil component of claim 1, wherein a second resistivity indicating a volume resistivity of the second region is larger than a first resistivity indicating a volume resistivity of the first region.

3. The coil component of claim 1, wherein a second permeability indicating a magnetic permeability of the second region is larger than a first permeability indicating a magnetic permeability of the first region.

4. The coil component of claim 1, wherein a dimension of the second region in the first direction is 3 μm or smaller.

5. The coil component of claim 1,
wherein a bottom surface of the first conductor pattern is opposed to a top surface of the second conductor pattern, and
wherein the second region covers an entirety of the bottom surface of the first conductor pattern.

6. The coil component of claim 1, wherein an end of the second region is exposed from the magnetic base body.

7. The coil component of claim 1, wherein the second region is in contact with at least the first conductor pattern.

8. The coil component of claim 7, wherein the second region is in contact with both the first conductor pattern and the second conductor pattern.

9. The coil component of claim 1, wherein as viewed from a direction of the coil axis, an area of the second region is larger than both an area of the first conductor pattern and an area of the second conductor pattern.

10. The coil component of claim 1,
wherein the plurality of metal magnetic particles contain Cr, and
wherein the magnetic base body contains ZnCr₂O₄ at an interface between the first region and the second region.

11. The coil component of claim 1, wherein in a sectional surface of the magnetic base body cut along a cutting plane passing through the coil axis, an area occupied by the second region is 1% to 10% of an area of the sectional surface.

12. The coil component of claim 1, wherein the second region is also located between the second conductor pattern and the first external electrode and between the second conductor pattern and the second external electrode.

13. A method of manufacturing a coil component, comprising the steps of:
forming a plurality of laminated sheets each including a green first magnetic sheet and a green second magnetic sheet, the green first magnetic sheet containing a magnetic powder, the green second magnetic sheet covering at least a part of a top surface of the green first magnetic sheet and containing Fe₂O₃ powder, ZnO powder, and NiO powder;
forming a conductor pattern on a top surface of each of the plurality of laminated sheets so as to cover at least a part of the green second magnetic sheet;
stacking the plurality of laminated sheets to form a laminate;
heating the laminate to form a magnetic base body; and
providing an external electrode on the magnetic base body.

14. The method of manufacturing a coil component according to claim 13, wherein the laminate is heated at a temperature of 800° C. to 1000° C.

15. The method of manufacturing a coil component according to claim 13, wherein in the step of heating, ZnCr₂O₄ is produced at an interface between the green first magnetic sheet and the green second magnetic sheet.
